(19) United States
(12) Patent Application Publication
(10) Pub. No.: US 2018/0297041 A1
(43) Pub. Date: Oct. 18, 2018

(54) LABOR-SAVING WATER OUTPUT SWITCHING DEVICE

(71) Applicant: Runner (Xiamen) Corp., Xiamen (CN)

(72) Inventor: WEI-WU SU, Xiamen (CN)

(21) Appl. No.: 15/951,151

(22) Filed: Apr. 11, 2018

(30) Foreign Application Priority Data
Apr. 13, 2017 (CN) 201720385790.9

(51) Int. Cl. B05B 1/16; B05B 12/00

(52) U.S. Cl. CPC B05B 1/1645; B05B 12/002

(57) ABSTRACT

A labor-saving water output switching device includes: a main body, a water diversion seat, a water diversion disk, and a water diversion chamber formed between the water diversion seat and the main body and in communication with a water inlet channel. The water diversion seat is provided with a pressure release channel in communication with the water diversion chamber. The switching device includes a switch having a lever structure, a transmission rod, and a lower ratchet. An upper ratchet is disposed corresponding to a lower ratchet of the water diversion disk, both act in cooperation to drive the water diversion disk into rotation. One end of the transmission rod is connected to move with the switch, while the other end is used to open or close the pressure release channel, and to act in cooperation with the lower ratchet in transmission.

### BACKGROUND OF THE INVENTION

### Field of the Invention

The present invention relates to a water output switching device, and in particular to a labor-saving water output switching device.

### The Prior Arts

In general, in the present technology, the switching mechanism is disposed in the water flow channel, to switch the water flow into various types of water output as required. Since the water flow exerts certain pressure on the switching mechanism, in switching, the user usually must make great effort to overcome the water pressure to achieve switching, thus causing quite inconvenience to the user. In some extreme conditions, the overly great water pressure may damage the switching mechanism.

Therefore, presently, the design and performance of the water output switching device is not quite satisfactory, and it leaves much room for improvement.

### SUMMARY OF THE INVENTION

In view of the problems and drawbacks of the prior art, the present invention provides a labor-saving water output switching device, that is novel in design, and labor saving in operation.

The present invention provides a labor-saving water output switching device, that includes: a main body, a water inlet channel, a water diversion seat, a water diversion disk, a pressure release channel, a switch, a lower ratchet, an upper ratchet, and a transmission rod. The water inlet channel is disposed in the main body. The water diversion seat is disposed in the main body and having a plurality of water diversion holes, a water diversion chamber is formed between the water diversion seat and the main body, and the water diversion chamber is in communication with the water inlet channel. The water diversion disk is disposed in the main body and having a plurality of water diversion holes, the water diversion disk is located in the water diversion chamber, and the water diversion disk is connected rotatably to the water diversion seat. The pressure release channel is disposed in the water diversion seat, and the pressure release channel is in communication with the water diversion chamber. The switch is provided with a lever structure. The upper ratchet is disposed in the water diversion disk, and the upper ratchet is located corresponding to the lower ratchet, both act in cooperation to bring the water diversion disk into rotation. The transmission rod has its one end acting together with the switch, and with its other end used to open or close the pressure release channel, to act in transmission cooperation with the lower ratchet.

In an aspect of the present invention, the labor-saving water output switching device further includes: an elastic piece, that is used to press against a position between the switch and the main body.

In another aspect of the present invention, the labor-saving water output switching device further includes: a fixing seat and a hold rod connected to the fixing seat, the water diversion seat acts in cooperation with the fixing seat to form the water diversion chamber, and the water inlet channel is formed in the hold rod.

In a further aspect of the present invention, in the labor-saving water output switching device, the switch includes: a pry rod connected rotatably onto the hold rod; a wrench connected rotatably onto the hold rod, the wrench acts in transmission cooperation with one end of the pry rod; and a pull rod, acting in cooperation with the other end of the pry rod, to form the lever structure.

In a more aspect of the present invention, in the labor-saving water output switching device, the fixing seat is provided with a penetrating position reserving hole, the pull rod is extended from top to bottom through the position reserving hole into the water diversion chamber, the pull rod acts in tight sliding cooperation with the position reserving hole.

In a further aspect of the present invention, in the labor-saving water output switching device, the transmission rod penetrates from top to bottom through the lower ratchet and the water diversion disk in sequence to connect and fix onto the pull rod.

Compared with the Prior Art, the labor-saving water output switching device of the present invention has the following advantages. In the present invention, the water diversion seat and the pressure release channel in communication with water diversion chamber are provided. The switch structure includes a switch having a lever structure, a transmission rod, and a lower ratchet. The upper ratchet is disposed corresponding to the lower ratchet of the water diversion disk, to act in cooperation with each other, to drive the water diversion disk into rotation. One end of the transmission rod is connected to move with the switch, while the other end of the transmission rod is used to open or close the pressure release channel, and is in cooperation with the lower ratchet in transmission. By utilizing the switch having the lever structure, water switching is made easier and labor saving. The switch can be placed in a position as required, so that it can be put in a place having larger space. Through the disposition of the pressure release channel, the switch is made to bring the transmission rod to move, to open the pressure release channel to release pressure, and to reduce the switching force required. As such, water switching is made labor saving, to provide an improved hand feel experience for the user.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is a perspective view of a labor-saving water output switching device according to the present invention;

FIG. 2 is an exploded view of a labor-saving water output switching device according to the present invention;

FIG. 3 is a cross section view of a labor-saving water output switching device according to the present invention when the water release channel is closed; and

FIG. 4 is a cross section view of a labor-saving water output switching device according to the present invention when the water release channel is open.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

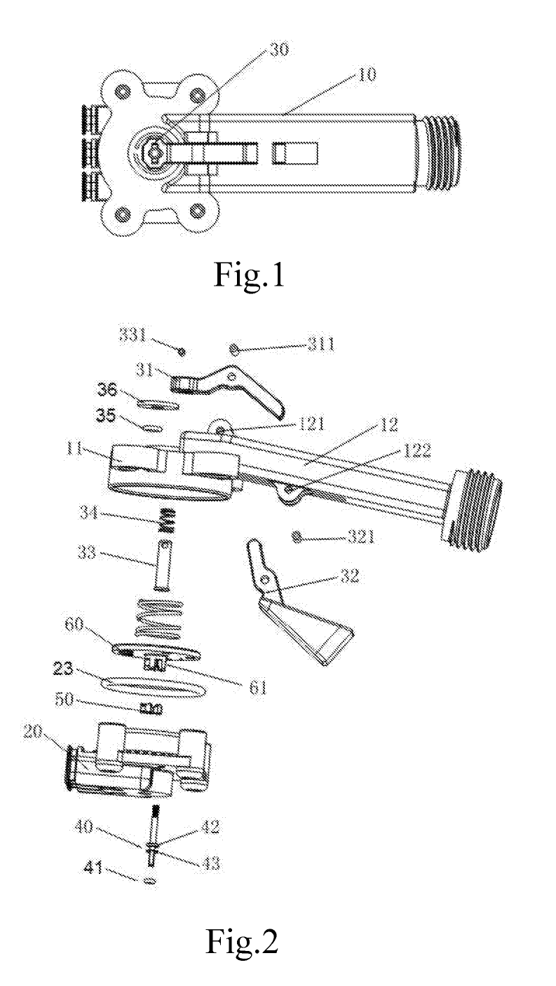

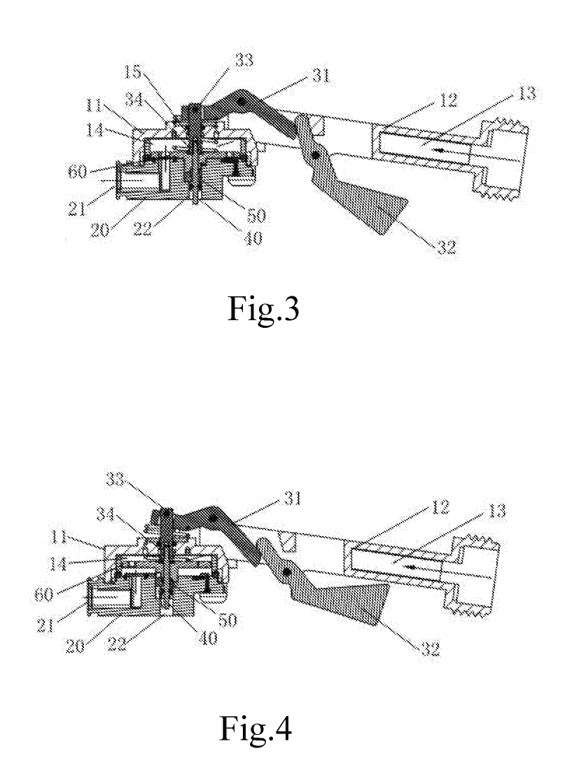

Refer to FIGS. 1 to 4 respectively for a perspective view of a labor-saving water output switching device according to the present invention; an exploded view of a labor-saving water output switching device according to the present invention; a cross section view of a labor-saving water output switching device according to the present invention when the water release channel is closed; and a cross section view of a labor-saving water output switching device according to the present invention when the water release channel is open.

As shown in FIGS. 1 to 4, the present invention provides a labor-saving water output switching device, that includes: a main body 10, a water inlet channel 13, a water diversion seat 20, a water diversion disk 60, a pressure release channel 22, a switch 30, a lower ratchet 50, an upper ratchet 61, and a transmission rod 40. The water inlet channel 13 is disposed in the main body 10. The water diversion seat 20 is disposed in the main body 10 and having a plurality of water diversion holes, a water diversion chamber 14 is formed between the water diversion seat 20 and the main body 10, and the water diversion chamber is in communication with the water inlet channel 13. The water diversion disk 60 is disposed in the main body 10 and having a plurality of water diversion holes, the water diversion disk 60 is located in the water diversion chamber, and the water diversion disk 60 is connected rotatably to the water diversion seat 20. The pressure release channel 22 is disposed in the water diversion seat 20, and the pressure release channel 22 is in communication with the water diversion chamber. The switch 30 is provided with a lever structure. The upper ratchet 61 is disposed in the water diversion disk 60, and the upper ratchet 61 is located corresponding to the lower ratchet 50, both act in cooperation to bring the water diversion disk 60 into rotation. The transmission rod 40 has its one end acting together with the switch 30, and with its other end used to open or close the pressure release channel 22, to act in transmission cooperation with the lower ratchet 50. In the present invention, the upper ratchet 61 and the lower ratchet 50 act in cooperation by means of the ratchet teeth, and that is widely utilized in the present technology, so it will not be repeated here for brevity.

In an embodiment of the present invention, the labor-saving water output switching device further includes an elastic piece 15, that is used to press against a position between the switch 30 and the main body 10.

In an embodiment of the present invention, the labor-saving water output switching device further includes: a fixing seat 11 and a hold rod 12 connected to the fixing seat 11. The water diversion seat 20 acts in cooperation with the fixing seat 11 to form the water diversion chamber 14. To be more specific, the outer wall of the water diversion seat 20 is sleeved with a first tight seal ring 23, to form tight connection with the fixing seat 11. and the water inlet channel 13 is formed in the hold rod 12.

In an embodiment of the present invention, the switch (30) includes: a pry rod 31 connected rotatably onto the hold rod 12; a wrench 32 connected rotatably onto the hold rod 12, the wrench 32 acts in transmission cooperation with one end of the pry rod 31; and a pull rod 33, acting in cooperation with the other end of the pry rod 31, to form the lever structure. To be more specific, on the hold rod 12 is provided with a first rotation axis hole 121 and a second rotation axis hole 122. The pry rod 31 is disposed and connected rotatably in the first rotation axis hole 121 through using the first pin 311. The wench 32 is disposed and connected rotatably in the second rotation axis hole 122 through using the second pin 321. The pull rod 33 is connected rotatably to the pry rod 31 through using the third pin 331, and it can be swung upward and downward along with the pry rod 31.

In an embodiment of the present invention, in the labor-saving water output switching device, the fixing seat 11 is provided with a penetrating position reserving hole 15, the pull rod 33 is extended from top to bottom through the position reserving hole 15 into the water diversion chamber 14, the pull rod 33 acts in tight sliding cooperation with the position reserving hole. To be more specific, the upper end of the position reserving hole 15 is provided with the second tight seal ring 35, a fastening cover 36 fixes the second tight seal ring 35 onto the upper end of the position reserving hole 15. The second tight seal ring 35 acts in tight contact cooperation with the outer wall of the pull rod 33.

In an embodiment of the present invention, the transmission rod 40 penetrates from top to bottom through the lower ratchet 50 and the water diversion disk 60 in sequence to connect and fix onto the pull rod 33. To be more specific, on the transmission rod 40 is provided with an upper protrusion edge 42 and a lower protrusion edge 43 spaced apart. A third tight seal ring 41 is fixed to a position between the upper protrusion edge 42 and the lower protrusion edge 43. The lower ratchet 50 is pressed against an upper edge of the upper protrusion edge 42. When the transmission rod 40 closes the pressure release channel 22, the third tight seal ring 41 is in tight contact cooperation with the inner wall of the pressure release channel 22. The upper end of the transmission rod 40 is provided with outer threads, the pull rod 33 is provided with corresponding inner threads, to achieve screw connection cooperation of the transmission rod 40 and the pull rod 33.

In application, pull one end of the wench 32 upward, with the other end of the wench 32 pressing the pry rod 31 downward, to make the pry rod 31 to rotate clockwise, to bring the pull rod 33 to move upward, so that the transmission rod 40 move upward along with the pull rod 33. At this time, the transmission rod 40 opens the pressure release channel 22, so that part of the water in the water diversion chamber 14 flows out from the pressure release channel 22, thus reducing the resistance to the upward movement of the water diversion disk 60. The transmission rod 40 uses the upper protrusion edge 42 to pull the lower ratchet 50 to move upward, to act in cooperation with the upper ratchet 61 to make the water diversion disk 60 to move upward and rotate, in achieving the water switching operation.

By utilizing the switch 30 having the lever structure, water switching is made easier and labor saving. The switch can be placed in a position as required, so that it can be put in a place having larger space. Through the disposition of the pressure release channel 22, the switch 30 is made to bring the transmission rod 40 to move, to open the pressure release channel 22 to release pressure, to reduce the switching force required. As such, water switching is made labor saving, to provide an improved hand feel experience for the user.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A labor-saving water output switching device, comprising:
a main body;
a water inlet channel, disposed in the main body;
a water diversion seat, disposed in the main body and having a plurality of water diversion holes, a water diversion chamber is formed between the water diversion seat and the main body, and the water diversion chamber is in communication with the water inlet channel;
a water diversion disk, disposed in the main body and having a plurality of water diversion holes, the water diversion disk is located in the water diversion chamber, and the water diversion disk is connected rotatably to the water diversion seat;
a pressure release channel, disposed in the water diversion seat, and the pressure release channel is in communication with the water diversion chamber;
a switch, provided with a lever structure;
a lower ratchet;
an upper ratchet, disposed in the water diversion disk, and the upper ratchet is located corresponding to the lower ratchet, both act in cooperation to bring the water diversion disk into rotation; and
a transmission rod, with its one end acting together with the switch, and with its other end used to open or close the pressure release channel, to act in transmission cooperation with the lower ratchet.

2. The labor-saving water output switching device as claimed in claim 1, further comprising: an elastic piece, used to press against a position between the switch and the main body.

3. The labor-saving water output switching device as claimed in claim 2, further comprising: a fixing seat and a hold rod connected to the fixing seat, the water diversion seat acts in cooperation with the fixing seat to form the water diversion chamber, and the water inlet channel is formed in the hold rod.

4. The labor-saving water output switching device as claimed in claim 3, wherein the switch includes: a pry rod connected rotatably onto the hold rod; a wrench connected rotatably onto the hold rod, the wrench acts in transmission cooperation with one end of the pry rod; and a pull rod, acting together with the other end of the pry rod, to form the lever structure.

5. The labor-saving water output switching device as claimed in claim 4, wherein the fixing seat is provided with a penetrating position reserving hole, the pull rod is extended from top to bottom through the position reserving hole into the water diversion chamber, the pull rod acts in tight sliding cooperation with the position reserving hole.

6. The labor-saving water output switching device as claimed in claim 5, wherein the transmission rod penetrates from top to bottom through the lower ratchet and the water diversion disk in sequence to connect and fix onto the pull rod.
